(19) United States
(12) Patent Application Publication
(10) Pub. No.: US 2003/0224796 A1
(43) Pub. Date: Dec. 4, 2003

(54) Method of assigning resources that vary in time to provide continuous services and application of the method to telecommunication system planning

(75) Inventors: Eric Landes, Toulouse (FR); Gerard Authie, Toulouse Cedex (FR); Fabienne Roussel, La Garenne-Colombes (FR); Jean-Francois Ereau, Toulouse (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/373,842

(22) Filed: Feb. 27, 2003

(30) Foreign Application Priority Data
Feb. 28, 2002 (FR) 02 02 549

(51) Int. Cl. H04Q 7/20

(52) U.S. Cl. 455/446; 455/427

(57) ABSTRACT

A method of planning communication links in a telecommunication system comprising a plurality of cells inside each of which is a ground station, in which system communications are effected via the ground stations and relay equipment carried by a constellation of satellites. Each of the satellites has a plurality of antennas and each of the antennas is adapted to remain pointed toward a ground station. Continuity of communications for each ground station is assured by switching the communications from one satellite to another satellite. For planning communication links over a particular programming time, graphs of intervals for the ground stations are used in which each node of a graph is an interval of potential use of equipment on board a satellite and each line is a pair of intervals having portions overlapping in time.

### CROSS-REFERENCE TO RELATED APPLICATIONS

This application is based on French Patent Application No. 02 02 549 filed Feb. 28, 2002, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a method of assigning resources that vary in time for providing continuous services. It relates more particularly to a method of this kind intended for planning communication links in a telecommunication system using nongeostationary satellites.

The present description refers mainly to a method of planning communication links in a telecommunication system using a constellation of satellites in low Earth orbit, which are therefore nongeostationary; other applications of the planning method are also described, but more succinctly.

2. Description of the Prior Art

The planning method applies more particularly to a telecommunication system in which the terrestrial globe is divided into zones or cells each of which has a radius of the order of a few hundred kilometers and a ground station is provided inside each cell. The terminals in each cell communicate with other terminals in that cell, with terminals in other cells or with other telecommunication systems via the ground station assigned to the cell concerned. All calls are transmitted via nongeostationary satellites. To provide a more concrete example, the description refers to the “Skybridge” system, a first deployment of which is described in a paper entitled “Skybridge: réseau multimedia haute vitesse par satellite.” by P. Sourisse and H. Sorre, published in Revue de l'electricité et de l'électronique, 11:49-52, December 1997. A later development of the same system includes several hundred ground stations and 80 nongeostationary satellites forming a Walker constellation.

In a telecommunication system of the above kind, because each satellite is in view from a cell for only a limited time period, for example of the order of 15 to 20 minutes, it is essential when a satellite is preparing to leave the view of the cell that another satellite be available and ready to take over the call in order for service not to be interrupted. This is why the constellation is organized so that at any time more than one satellite can be seen from each cell. What is more, the satellite that has to take over the call must also be visible at the same time as the previous satellite for long enough to allow handover.

Furthermore, a system is considered here, such as the Skybridge system, in which each satellite carries a limited number of active antennas which are controlled so that they can service the cells to which they are assigned despite the movement of the satellite relative to the cell concerned. This being so, when an antenna on board a satellite reaches the end of its time of assignment to a cell, that antenna is not immediately available because a minimum “rallying” time is required for the antenna to be repointed toward another cell.

Similarly, the antennas of the ground stations track the corresponding satellites. They must therefore also observe a rallying time.

When a telecommunication system of the above type has been installed with a plurality of satellites and a plurality of cells, i.e. ground stations, all of the connections, i.e. links, must be planned so that the links required by each ground station and each cell are provided continuously by a satellite. This planning is theoretically possible because of the deterministic nature of the orbits of the satellites. However, the large number of satellites and ground stations and the constraints indicated above make planning a problem that is far from easy to solve. Furthermore, the difficulty is increased if the number of constraints imposed on the system increases. One particular additional constraint is as follows:

It is preferable to limit the number of handovers from one satellite to another because this involves mobilizing two satellites simultaneously and necessitates signaling; also, the number of movements of the antennas on the satellites must be limited because these movements limit the service life of the satellites.

It is also preferable for each ground station to have at least one link that is provided continuously by a satellite.

The problem is made even more complex when the system is degraded, for example by the loss of a satellite and failure of antennas, transponders and/or repeaters. The problem can be made even more complicated by traffic variations, which can be either continuous, for example because of increased demand from one or more cells, or periodic, for example because of daily variations in call traffic.

To give a clear idea of the magnitude of the problem to be solved, consider by way of illustration a cycle of ten and a half hours and a system operating under steady state conditions and with no traffic variation. The object to be achieved is to ensure that each link requested by each ground station is continuously provided by a satellite. During this period, each of the ground stations is connected to 100 satellites on average. In the case of an end of life scenario encompassing many stations, a simple calculation shows that if constraints associated with carriers are taken into account in addition to the constraints mentioned above, planning this kind of system entails considering 400 000 Boolean variables that have to satisfy 4 000 000 constraints.

The invention starts from the observation that this problem can be solved with the aid of mathematical algorithms and that it is not possible to find an optimum solution to this complex problem, only approximate solutions.

The invention provides a particularly simple solution to the planning problem.

It is based on using graphs of intervals for the ground stations and/or for the satellites.

The intervals referred to are those for which a satellite is visible from a cell. An interval graph is obtained by replacing each time interval by a point referred to as a node and drawing lines between nodes if the intervals have elements in common. For each ground station to establish its connection(s) (i.e. logical link(s)) continuously over a particular period (for example around ten hours) it is necessary to establish, for each required logical link, at least one path (succession of nodes and lines) from the first to the last interval potentially usable by a satellite, i.e. from the first node to the last.

As there is a multiplicity of paths for each ground station, and each path leads to the mobilization of a resource, i.e. an antenna of a satellite, which is then unavailable for the other ground stations, the path(s) chosen for the ground station must not prevent the setting up of a path for the other ground stations.

A first aspect of the invention relates to situations in which it is necessary for a ground station to be able to call on a plurality of logical links during the same time period, i.e. ground stations for cells in which traffic is heavy. According to this first aspect of the invention, when a ground station must establish a plurality of logical links simultaneously in the same time period, it uses disjoint node logical links, i.e. logical links which have no node in common, except of course the start and end nodes (or intervals).

In other words, in this case, two logical links are prohibited from using the same time interval or period of potential use of an antenna of a satellite even if such potential uses are at different times.

This being so, each time that a satellite can be used for the logical link for the cell concerned, the antenna is used once only, and not more than once. This minimizes the number of handovers.

Furthermore, the choice of disjoint node paths allows reliance on mainly the interval graphs, because if it were necessary to divide an interval into portions the interval graph could not be used since, in a graph, an interval is a point, i.e. a non-divisible element.

According to a second aspect of the invention, which can be used regardless of the number of simultaneous logical links for a ground station, a search for L (L≧1) disjoint node paths is effected in the following manner:

For each ground station there is determined, firstly, all of the intervals (i.e. all of the nodes in a graph) that are necessarily taken by one of the L disjoint node paths searched for, such nodes being referred to as “L-articulation points”.

This determines the lines, i.e. the handovers, which are necessarily taken by one of the L disjoint node paths, these lines or handovers being referred to as “L-bridges”.

For each L-articulation point determined as above, an antenna of the corresponding satellite is reserved for a minimum time, and for each L-bridge determined as above (from an outgoing satellite to an incoming satellite), handover from the outgoing satellite is prohibited except to the incoming satellite, and handover to the incoming satellite is prohibited except from the outgoing satellite.

In a preferred embodiment of the invention, the L-articulation points are determined as follows:

In each ground station the number of satellites that can be seen from the cell (this number is known as the density) is determined at the start and at the end of each time interval (in this context a time interval is the period of time for which the satellite is visible above the cell), series of densities of the type L+1, L, L+1 are searched for, and the L-articulation point category is assigned to the time intervals that lie entirely within the density L.

The series of densities can also be used to detect L-bridges. In this case, series of densities of the type L, L+1, L are searched for. This kind of series corresponds either to the appearance and disappearance of the same visibility interval or to a handover. In the latter case, the L-bridge (or L-obligatory handover) category is assigned to the handover in a time segment L, L+1, L and corresponding to the handover from the time interval that is ending in this segment to remaining time intervals in the segment.

This method of determining the L-articulation points and the L-bridges, i.e. the determination of the satellite antennas to be reserved for establishing logical links by searching for particular series of densities, is particularly fast, simple and effective.

In one embodiment, to continue the determination of the logical links, after having temporarily reserved (using cell interval graphs) the L-articulation points and the L-bridges, for each satellite, there is considered, over the period concerned, all of the visibility intervals of the ground stations, for each ground station seen from the satellite an antenna of that satellite is reserved during all or part of the potential interval of use, and the ground stations that cannot be serviced by the satellites concerned because of the mobilization of all the antennas of that satellite for other ground stations are determined.

The satellite concerned can no longer use the periods of visibility while it is “saturated” (i.e. when all the antennas are in use).

The series of densities is then determined again for the graph of the ground station having a period of visibility trimmed in this way. Given that this series is modified by the trimming, it is then possible to find other L-articulation points and other L-bridges.

It can be seen that reservations of resources that approximate a satisfactory solution are obtained in this way each time, by propagation from the satellite graphs to the ground station graphs, and vice versa.

To obtain a solution other constraints must yet be imposed. For instance, the highest priority logical link (for example the cell corresponding to the greatest traffic) is given special status, and the succession of physical links (satellite antenna reservations) needed to obtain a continuous logical link is determined first.

Other criteria can also be imposed to facilitate the selection process, such as giving special status to the links with the greatest potential period of use and/or the links yielding the greatest residual capacity.

The first solution found, referred to as the initial solution, is generally not satisfactory because it yields admissible logical links and inadmissible logical links, i.e. links subject to interruption.

In one embodiment, to minimize or even eliminate the number of logical links subject to interruption, a metaheuristic method is used including an intensification step and a diversification step.

### SUMMARY OF THE INVENTION

The invention provides a method of planning communication links in a telecommunication system comprising a plurality of cells inside each of which is a ground station, in which system communications are effected via the ground stations and relay equipment carried by a constellation of satellites, each of the satellites has a plurality of antennas and each of the antennas is adapted to remain pointed toward a ground station when the satellite is in view of the ground station, continuity of communications for each ground station is assured by switching the communications from the equipment of one satellite to the equipment of another satellite, and:

for planning communication links over a particular programming time, graphs of intervals for the ground stations are used in which each node of a graph is an interval of potential use of equipment on board a satellite and each line is a pair of intervals having portions overlapping in time, and

in the graphs for the ground stations requiring a number L of communication links via different satellites at least equal to two, the communication links are determined by searching for L disjoint node paths.

In one embodiment, to determine the L disjoint node paths, in the graphs of intervals for the ground stations, the nodes which are necessarily taken by at least one of the L disjoint node paths are identified and are known as L-obligatory nodes.

In this case it is advantageous if, to identify the L-obligatory nodes, for each ground station, after each start and each end of an interval of potential use of equipment of each satellite, the density d for the station, defined as the number of intervals of potential use, is determined and series of densities of the form L+1, L, L+1 are searched for, the L-obligatory nodes being the intervals of potential use that do not terminate or do not commence when the density in the series is the density L.

In one embodiment, to determine L disjoint node paths for a ground station, L-obligatory handovers, defined as the lines that are necessarily taken by at least one of the disjoint node paths, are identified. In this case, to identify the L obligatory handovers, for each ground station, after each start and each end of an interval of potential use of equipment of each satellite, the density d for the station, defined as the number of intervals of potential use, is determined and series of densities L, L+1, L are searched for in which the variation of density is due to two different intervals, an L-obligatory handover being defined as a handover from the interval that is terminating on passing from the density L+1 to the density L to an interval that is beginning.

In one embodiment, for each satellite, a graph of intervals is established in which each interval corresponds to a duration of potential use of the satellite by a ground station, the number of antennas of the satellite that are in use at any time is determined, the ground station or stations that cannot be serviced if all the antennas of the satellite are mobilized for other stations are identified, and, in the graph or graphs corresponding to that ground station or those ground stations, the prohibition period is applied to the satellite over the corresponding interval.

In this case, and if the L-obligatory nodes are identified using a series of densities, for the ground station or stations in which a prohibition period for the interval of potential use of the corresponding satellite has been reported, the series of densities L+1, L, L+1 are searched for again in order to determine the L-obligatory nodes.

If the L-obligatory handovers are identified using a series of densities, for the ground station or stations in which a prohibition period for the interval of potential use of the corresponding satellite has been reported, the series of densities L, L+1, L are searched for again in order to determine the L-obligatory handovers.

In one embodiment, the propagation of constraints from the graphs of intervals of satellites to the graphs of intervals of ground stations and vice versa is effected until no situation of saturation is detected any longer, i.e. no satellite having, over a given time interval, visible ground stations that it does not use, but having all its antennas in use.

After establishing, during the programming time, communication links subject to interruption and communication links not subject to interruption, a metaheuristic method is used to reduce (or cancel out) the number of links subject to interruption. In this case, the method can include an intensification step for searching for local optimum solutions and a diversification step and wherein the searches for solutions are conducted over farther away neighborhoods during the diversification step. The intensification step searching for local optimum solutions is preferably effected only on links subject to interruption.

The diversification search can be effected on all of the communication links, i.e. those subjected and not subjected to interruption.

The invention also provides a method of planning a set N of requests for services competing for the allocation of M resources with identical characteristics, wherein each service i has to be rendered continuously over a time interval included in a period, the requests for services are divided into groups, each service is rendered by the use of an undifferentiated resource, which resources can render the service i during predefined time intervals known as intervals of potential use, the resources are divided into subsets, a resource is able to render only one service at a time, the requests for services of the same group cannot be rendered by resources belonging to the same subset, the passage from the use of one resource to the next necessitates the simultaneous use of two resources during a minimum duration, a released resource cannot be reused immediately to determine sequences of resources whose use guarantees at least two continuous services over the aforementioned period, a graph of intervals is determined for each request for service, each node consists of an interval of potential use of a resource and each line consists of a handover from one resource to another, and, for each request for service, the disjoint node paths are determined in the graph.

Other features and advantages of the invention will appear from the following description of some of the embodiments of the invention, which is given with reference to the accompanying drawings.

### BRIEF DESCRIPTION OF THE DRAWINGS

FIG. 1 is a diagram of a common telecommunication system to which the invention applies.

FIGS. 2 and 2a are graphs for a ground station illustrating one aspect of a method according to the invention.

FIG. 3 is a graph for a satellite illustrating another aspect of a method according to the invention.

FIG. 4 is a graph for a ground station illustrating a further aspect of the invention.

FIG. 5 is a diagram showing a metaheuristic method of searching for solutions.

FIGS. 6, 6a, 7 and 7a are ground station interval graphs for a local search neighborhood conforming to the invention.

FIGS. 8, 8a, 9 and 9a are graphs analogous to those of FIGS. 6, 6a, 7 and 7a for a diversification search neighborhood conforming to the invention.

### DETAILED DESCRIPTION OF THE PREFERRED EMBODIMENTS

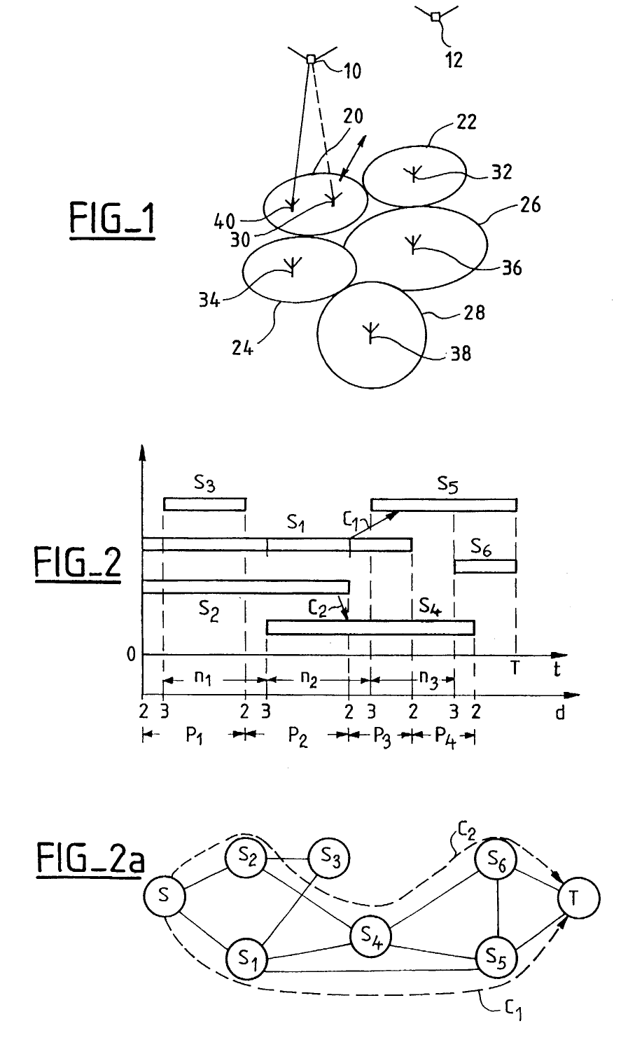

FIG. 1 is a diagram of a telecommunication system using nongeostationary satellites. In the system considered by way of example (which is of the Skybridge type referred to above) there is a set of satellites 10, 12, etc. in medium Earth orbit forming a Walker constellation covering most of the terrestrial globe.

The Earth is divided into zones or cells 20, 22, 24, 26, 28, etc., and in each cell there is a respective ground station 30, 32, 34, 36, 38, etc. for relaying all calls sent or received by terminals in the corresponding cell. Calls are relayed by one or more satellites 10, 12 which can be seen from the cell.

Thus a terminal 40 of the cell 20 communicates with another terminal of the same cell 20, a terminal of another cell or another network via, firstly, a satellite, such as the satellite 10, then via the station 30, and then via the same satellite or another satellite with another terminal of the same cell. If the destination terminal does not belong to the same station as the source terminal, it may be necessary to effect a transfer between two stations. The station 30 can equally be connected to a terrestrial or other network of another telecommunication system.

Each satellite carries n active antennas, for example nine antennas, and each antenna is reserved for a single cell. These antennas are constantly pointed toward the cell that they service, the pointing direction therefore moving continuously as the satellite passes overhead.

Because it is generally necessary for there to be no interruption of service in a telecommunication system, when a satellite is preparing to cease servicing a cell, for example because it is crossing the horizon of the cell when one of its antennas is being used to relay calls for that cell, it is clear that another satellite must be ready to take over all the calls and that switching from one satellite to another must occur when that whose use is about to cease is still usable, i.e. in view. Thus the constellation and the cells are such that at all times more than one satellite can be seen from each cell.

To cater for heavy traffic, the number of satellites is also sufficient so that, for some cells at least, calls can transit at all times via more than one satellite.

To switch from one satellite to another it is also necessary to allow for the rallying time of the antennas, i.e. the time needed for an antenna of the ground station and an antenna on the satellite to be pointed at each other. This time is 10 seconds for a satellite antenna and 20 seconds for a ground station antenna, for example.

Clearly, in the above kind of telecommunication system planning is a problem that is not simple to solve, given the large number of parameters involved, namely the number of cells, the number of satellites, the number of antennas on each satellite, the number of antennas at each ground station, etc. These constraints are all the more difficult to satisfy when it is preferable for all calls for all cells to be maintained continuously. Any interruption of service, even of short duration, degrades the service provided, which is unacceptable for some forms of communication, for example for transmitting programs.

From the planning point of view, it is also preferable to limit the number of handovers from one satellite to another, as handover entails the simultaneous use of two antennas in the ground station and two satellites. Also, handover leads to additional processing time in the ground station and to signaling traffic for the purposes of link management.

Thus the object of the planning process is, over a given time period, to enable the provision of continuous logical links, preferably for all cells. Even if it is not possible to satisfy this condition for all cells, it is preferable to minimize the number of links on which calls may be interrupted. Furthermore, planners must assign a special status to logical links that minimize the number of handovers. A special status is preferably also assigned to the use of satellites at a high elevation, since these provide the best communication quality. To guarantee that all the satellites have a consistent service life, it is preferable to divide the load equitably between the satellites, as it is necessary to avoid always calling on the same satellites.

Planning models the allocation of links from each ground station and the allocation of links from each satellite, the modeling being based in each case on interval graphs, and constraints are propagated between ground station interval graphs and satellite graphs. Finally, a metaheuristic method, i.e. an approximate method, is used to obtain one or more solutions.

Planning consists of determining, over a particular time period, for example 10.5 hours, all the physical links between ground stations and satellites to be provided for the whole of the telecommunication system. This time period [0, T] corresponds to a period of the constellation of satellites, i.e. at times 0 and T there is a satellite in exactly the same position, subject to permutation of the satellite numbers.

To simplify the planning problem, ground station interval graphs are used first, as shown in FIGS. 2 and 2a.

In the FIG. 2 diagram, time t is plotted on the abscissa axis and the time periods during which the satellites S1, S2, S3, S4, S5 and S6 can be seen from the ground station and from the terminals are shown above the time axis t. These intervals S1, S2, S3, S4, S5 and S6 are intervals of potential use by the ground station GI of the equipment on board each of the satellites.

FIG. 2a is an interval graph corresponding to FIG. 2. In this kind of graph each interval is represented by a point S1, S2, . . . , S6 called a node.

Lines connect two nodes when the corresponding intervals have an overlap period. Thus in FIG. 2a a line a₂₃ links the nodes S2 and S3, because these have an overlap period. On the other hand, there is no line between the nodes S3 and S6, nor between the nodes S3 and S4 or S3 and S5, because the interval S3 does not overlap any of the intervals S4, S5 and S6.

In this graph, the starting time, i.e. the time t=0, is denoted by a node S and the terminating time t is denoted by a node T.

Programming consists of determining paths on the lines between nodes so that it is possible to start from the node S and terminate at the node T. FIG. 2a shows two paths C1 and C2: the path C1 starts from the node S and terminates at the node T via the nodes S1 and S5 and the path C2 passes via the nodes S2, S4 and S6.

The paths C1 and C2 are also shown in FIG. 2 to show the correspondence with the intervals.

To limit the number of handovers required, a ground station can use the same period of visibility, i.e. the same time interval (or node) S1, S2, S3, S4, S5, S6, only once.

In the FIG. 2a graph, this constraint is represented by the fact that the disjoint node paths must be searched for in the same interval graph. In other words, when the same station must assure two or more logical links during the period [0 T], paths that have no nodes in common are chosen, such as the paths C1, C2 in FIG. 2a.

To search for the L disjoint node paths in an interval graph, the connections (nodes) and the L-obligatory handovers (lines) are searched for.

The L-obligatory handovers, also known as L-articulation points, are the intervals (nodes) necessarily taken by one of the L disjoint node paths. In the FIG. 2a graph, it can be seen that the nodes S2, S4, S6 and S1, S5 are L-articulation points.

The L-obligatory handovers, also known as L-bridges, are handovers used for at least one of the L disjoint node paths.

The FIG. 2a graph shows that the lines 52-S4, S4-S6 and S1-S5 constitute L-bridges.

The invention provides a particularly simple method of searching for L-articulation points and L-bridges.

As shown in FIG. 2, this method takes into consideration densities d defined as the numbers of satellites seen from a station after each start and each end of an interval.

Thus at time t=0 the station can see the two satellites S1 and S2 and the density is therefore 2. After the start of the interval S3 the station can see three satellites. After the end of the interval S3 the station can see two satellites, and so on.

To determine the L-articulation points over this series of densities the series (L+1, L, L+1) are searched for. In this series, the L nodes (intervals) corresponding to the intermediate density L constitute L-articulation points.

Thus in the FIG. 2 example two disjoint node paths are searched for (i.e. L=2). There are three series of densities (3,2,3) labeled n₁, n₂ and n₃.

The nodes S1 and S2 correspond to the first series n₁. The nodes S1 and S4 correspond to the second series n₂ and the nodes S4 and S5 correspond to the third series n₃. It has therefore been determined that the nodes S1, S2, S4 and SS constitute nodes through which two disjoint node paths pass.

Also, to determine the L-bridges, i.e. the handovers necessarily effected by one of the L disjoint node paths, there is also taken into consideration the series of densities and a search is conducted for the series (L, L+1, L) induced by a handover, and an L-bridge corresponds to a handover from the disappearing interval to the appearing interval on passing from the density L+1 to the density L.

The FIG. 2 example shows that it is possible to detect four series (2,3,2) labeled p₁, p₂, p₃ and p₄. The series p₂ supplies the handover (line) S2-S4. The series p₃ supplies the handover S1-S5 and the series p4 supplies the handover S4-S6.

Note that because it is induced by a single interval, the first series (2,3,2), labeled p₁, does not correspond to an L-bridge.

When an L-articulation point (a node that is necessarily used) has been determined, an antenna of the corresponding satellite is reserved with a minimum time of use.

When an L-bridge has been determined, for example a line S2-S4, any other handover or line is prohibited for the outgoing interval (S2), i.e. the interval S2 can hand over only to the interval S4 and not to any other.

Similarly, any other handover or line is prohibited for the incoming interval (S4), i.e. only the interval S2, and none other, can hand over to the interval S4.

Satellite interval graphs are used to continue the determination of the logical links for each ground station.

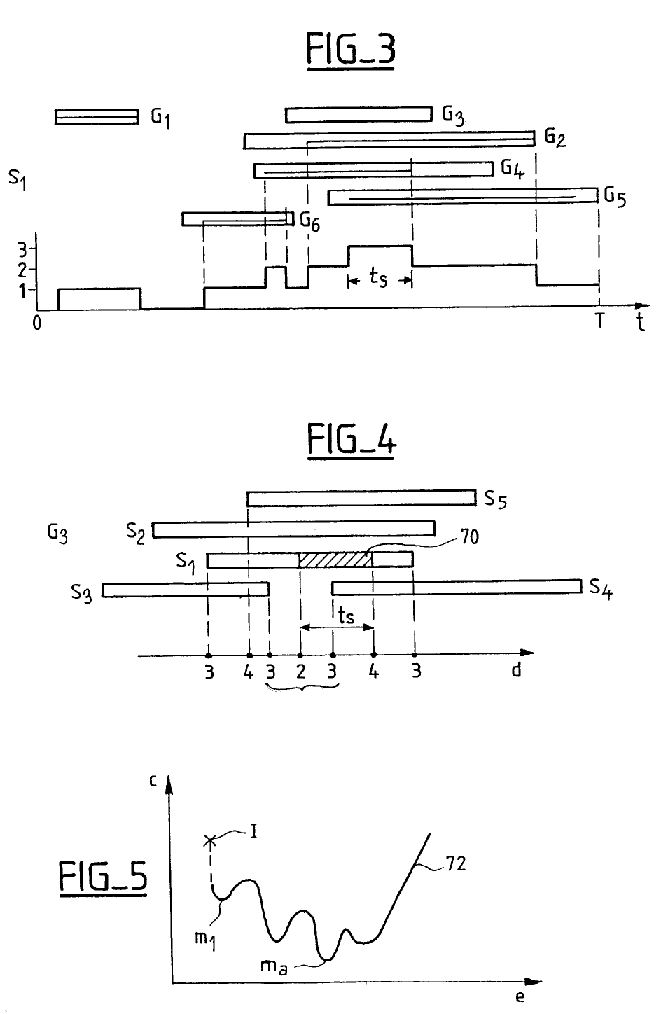

FIG. 3 shows an interval graph for a satellite S1 and a profile of use of the antennas of that satellite.

In this simplified example, it is assumed that the satellite S1 has only three antennas.

Over the period [0 T] the satellite S1 can service the stations G1, G2, G3, G4, G5 and G6.

FIG. 3 also shows the profile of use of the satellite S1, i.e. the number of antennas in use at any time. That number is equal to 0, 1, 2 or 3. When the satellite S1 is in view of the station G1 only one antenna is used. After its availability to the station G1, and before it is in view from the station G6, no station is in view; the satellite S1 is available. Then the station G6 is in view, and an antenna is reserved. A second antenna of the satellite S1 is then reserved to service the station G4 afterward. When the station G6 leaves the field of view of the satellite S1, an antenna is freed which can then be used by the station G2. The station G5 is then serviced, at which time the stations G2 and G4 are still communicating with the satellite S1. As a result, when the stations G2, G4 and G5 are serviced simultaneously, all the resources of the satellite are mobilized and the satellite therefore cannot service the station G3.

The FIG. 3 graph is then used to modify the graph for the station G3, by incorporating into the latter the fact that the satellite S1 is not available during the period t₅.

FIG. 4 shows the graph for the station G3. Like FIG. 2, this figure shows densities.

It can be seen that the interval of potential use of the satellite S1 by the station G3 includes a zone 70 (see FIG. 4), shown shaded, which corresponds to the time interval t₅ during which the satellite S1 cannot be used for that station.

Two logical links must be established by the station G3. It is therefore necessary to detect the series of densities (3,2,3). This kind of series of densities (3,2,3), and thus an L-articulation point, is detected after the appearance of the segment 70 leading to the updating of the G3 interval graph. Accordingly, after the segment 70 has been determined, it is found that the intervals S2 and S5 can be reserved for the station G3, whereas these intervals S2 and S5 were not obligatory before this.

Following this reservation of the nodes S2 and S5, the profiles of use can be recalculated for the satellites S2 and S5, which leads to reconsidering the graphs for the stations, and so on.

Thus there is a propagation of constraints, as it were, which continues until no further saturation is detected.

Thus, after this processing, all the L-obligatory connections and all the L-obligatory handovers of the interval graphs of all the stations have been calculated.

The constraints propagation technique is of benefit not only for initial planning of the telecommunication system but also to an operator wishing to modify resource allocation plans. The planning method enables the consequences of new allocations to be determined quickly.

When, for each ground station, all of the L-articulation points and all of the L-bridges have been determined, it is then necessary to determine all of the links for approximating the required solution, namely, during the programming period [O T] to obtain continuous communication for each ground station despite the discontinuities due to the movement of the satellites and the limited number of antennas and transponders, and despite the diverse constraints referred to above.

To this end an initial solution, i.e. an allocation of links, is determined first, using a “glutton” algorithm.

This algorithm determines the handovers for the physical links from a list of physical links classified in priority order.

To this end, the greatest number of physical links is determined by modeling that searches for a maximum stream in a network at the starting time. Modeling that searches for a maximum stream is described, for example, in “Network flows. Theory, algorithms and applications.”, R. K. AHUJA, T. L. MAGNANTI and J. B. ORLIN, Prentice Hall, 1993.

At the end of execution of the glutton algorithm, complete logical links, i.e. links with no interruption of service, and incomplete logical links, which violate the continuity of service constraint, are obtained.

In one embodiment, a metaheuristic method is used to reduce the number of incomplete logical links, and includes an intensification step and a diversification step.

These methods are generally known for determining solutions to problems with large numbers of variables. Diverse metaheuristic methods are described in a paper by I. OSMAN and G. LAPORTE “Metaheuristics: a bibliography”, published in “Annals of operations research” 63: 73-523, 1996.

Metaheuristic methods move in a solutions space with the aid of a neighborhood, i.e. look for adjacent solutions in the solutions space, a neighborhood being defined by a modification of the characteristics of the solutions, for example using graph theory.

Local optima are searched for in the solutions space during the intensification step.

To illustrate metaheuristic methods, refer to the FIG. 5 diagram in which the solutions space e is plotted on the abscissa axis and a criteria C plotted on the ordinate axis must be minimized to obtain a solution. In this diagram, the point I constitutes the initial solution and the intensification step consists of using neighborhoods to search for a local minimum that is the local minimum m₁ in the case of the curve 72 in FIG. 5.

After a local minimum or optimum has been determined, the neighborhood criteria are degraded to escape from the local optima. This is a diversification step, intended to approximate the absolute optimum ma, it being understood that it is practically impossible, in this type of problem, to prove that an absolute optimum has been found.

In the example, both for the intensification step and for the diversification step, a variable neighborhood search is used. The method is described by N. MLADENOVIC and P. HANSEN in a paper “Variable neighborhood search” published in “Computers Operations Research” 24(11):1097-1100, 1997.

During the variable neighborhood search, increasing order neighborhoods are determined. From the best current solution, a random solution A′ is determined using the first neighborhood and a local search is then effected from that random solution. If the solution A″ obtained from the local search is of better quality than the best solution A, the variable neighborhood search continues, using A′ as the initial solution and starting again from the diversification neighborhood. If not, the order of the neighborhood is incremented and another random solution is generated from the solution A, using the new neighborhood order, and this continues until all the diversification neighborhoods have been used.

To adapt the variable neighborhood search process to the present planning problem, it is necessary to determine the set of neighborhoods to be used for the intensification and diversification steps.

To this end, for the intensification step, only better solutions for the incomplete links are searched for.

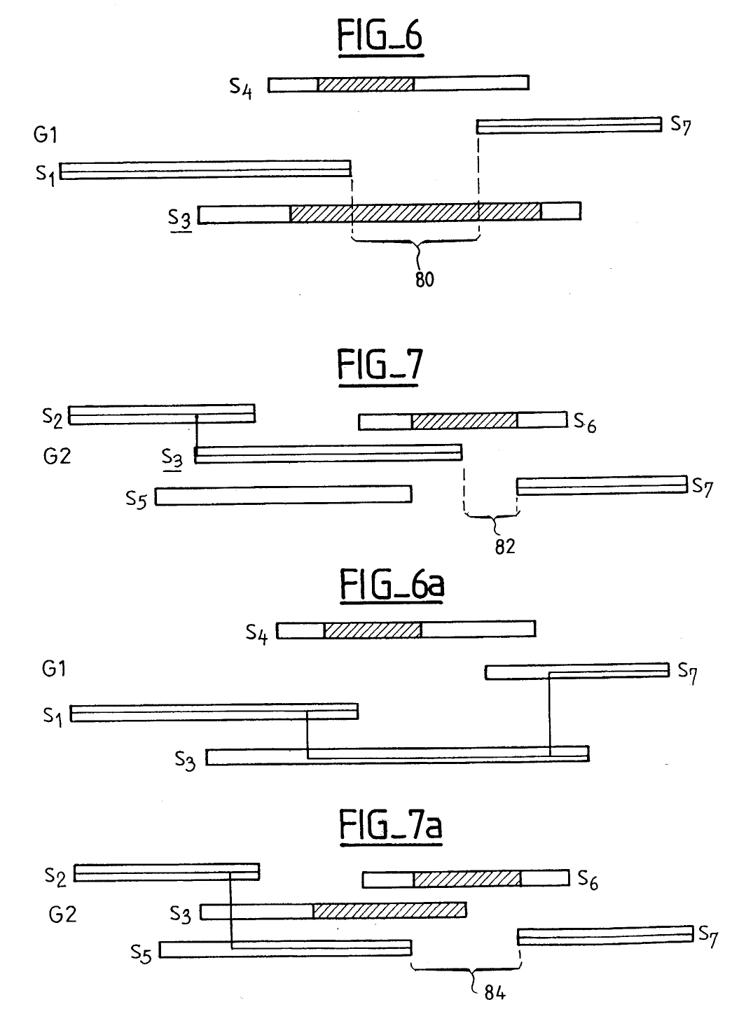

For example, the initial solution for the ground stations G1 and G2 is shown in FIGS. 6 and 7, respectively.

It can be seen that, over the programming period, the station GI suffers a break 80, the links via the satellites S3 and S4 being unavailable during their period of visibility from the corresponding cell. On the other hand, the intervals S1 and S7 are available.

In the example shown in FIG. 7, the station G2 sees the intervals S2 and S3, S5, S6 and S7 during the programming period, the intervals S2, S3 and S7 being used. However, a break 82 occurs between the intervals S3 and S7, the interval S6 being unavailable.

For this intensification step, the intervals S1 for G1 and S2 for G2 are retained and resources are freed in order to search for logical links using a glutton search.

A continuous link S1-S3-S7 is obtained in this way for G1 (see FIG. 6a). On the other hand, the glutton search for G2 terminates in establishing the links S2 and S5 and thereafter using the link S7. A break 84 therefore still occurs (see FIG. 7a). Clearly the change from FIGS. 6 and 7 to FIGS. 6a and 7a has improved the overall solution.

The diversification neighborhood search consists of authorizing a neighbor which degrades the solution.

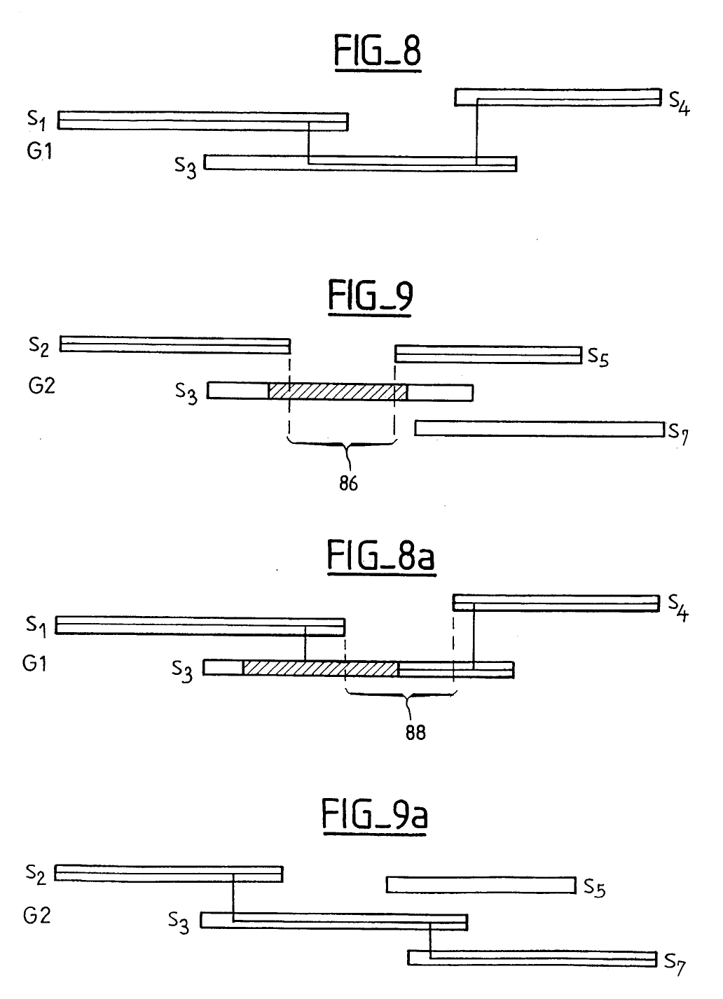

Accordingly, another highly simplified example, shown in FIGS. 8 and 9, starts with a solution in which, for the station G1, there is available at the outset a logical link S1-S3-S4 (see FIG. 8), while the logical link for the station G2 is incomplete: S2-break 86-S5 (see FIG. 9).

A diversification neighborhood search consists, first of all, of exploring the inadmissible solution of using the interval S3 anyway, despite the break 86 which results from the fact that the satellite S3 has no antenna available because all its antennas are already in use (saturation). This solution is shown in FIG. 9a, which indicates that the station G2 uses the intervals S2-S3-S7.

To make this solution admissible, it is then necessary to eliminate the constraint violation. A break 88 is therefore generated for the logical link from the station G1 (see FIG. 8a). In effect, the interval S3 is freed at the expense of the station G1.

To obtain a solution of better quality, an intensification step must be applied again.

The planning methods described hereinabove are general methods with applications in fields other than telecommunication systems.

Thus the planning method according to the invention can be applied to air traffic control. The airspace of a country or a region is divided into sectors each of which has its own air traffic control station. Each flight must pass through contiguous sectors in order to be tracked continuously by a control station, and a control station can track simultaneously only a limited number of flights. The problem of searching for flight paths is similar to the problem of allocating links in a constellation of satellites. A flight corresponds to a ground station and a control station corresponds to a satellite. In other words, in the case of air traffic control, the resources (control stations) are fixed and the requests for service move in time, whereas for telecommunication system planning, the resources (satellites) are mobile and the service requests (ground stations) are mobile.

The methods described also apply to production management and satellite imaging.

This generalization results from the fact that the problem of allocating links in a constellation of satellites can be generalized to a problem of allocating resources formulated in the manner explained below, this problem starting from the following hypotheses:

A set of D requests for service is to be satisfied using a set of R resources with identical characteristics. Each request for service i must be satisfied over a time interval

$$⌊ {t}_{i}^{o} , {t}_{i}^{f} ⌋ .$$

As the resources are undifferentiated, a request for service can be satisfied by any resource.

The constraints that apply to the resources and the requests for service are expressed in the following manner:

A resource can satisfy only one request for service at a time.

Each resource j can satisfy a request for service i over a set of kᵢⱼ time intervals:

$$\{ [ {B}_{ij}^{k} , {E}_{ij}^{k} ] / k = 1 , … , kij \}$$

These time intervals are intervals of potential use. Outside these time intervals, the request for service i cannot be satisfied by the resource j.

Each request for service i must be continuously satisfied over the time interval

$$⌊ {t}_{i}^{o} , {t}_{i}^{f} ⌋$$

in other words, for each t∈

$$t ∈ ⌊ {t}_{i}^{o} , {t}_{i}^{f} ⌋$$

the request for service i must be associated with a resource j. Because a resource can satisfy a request for service only during limited time intervals, this continuity of service constraint imposes the use of a succession of resources to satisfy the request for service over the whole of the interval

$$⌊ {t}_{i}^{o} , {t}_{i}^{f} ⌋ .$$

The additional resources and requests for services constraints are as follows:

The change from one resource to the next is not instantaneous. It necessitates the simultaneous use of the two resources during a given transition period.

A resource is not immediately usable after it is released by a request for service. It is unavailable during a given release period.

Thus the general problem to be solved is that of continuously satisfying all requests for service using the available resources.

For each request for service i, it is necessary to determine a sequence of Nᵢ admissible resources. The sequence consists of Nᵢ triplets

$$( {b}_{i}^{k} , {e}_{i}^{k} , {j}_{i}^{k} )$$

for k=1, . . . , Nᵢ where bᵢ^{k} and eᵢ^{k} are the start and end dates of the k^{th} component of the service i rendered by the resource jᵢ^{k}. The number Nᵢ of components of a sequence is a variable of the problem. A secondary objective is to minimize the number of components in the sequences.

There is claimed:

1. A method of planning communication links in a telecommunication system comprising a plurality of cells inside each of which is a ground station, in which system communications are effected via said ground stations and relay equipment carried by a constellation of satellites, each of said satellites has a plurality of antennas and each of said antennas is adapted to remain pointed toward a ground station when said satellite is in view of said ground station, continuity of communications for each ground station is assured by switching said communications from said equipment of one satellite to said equipment of another satellite, and:
for planning communication links over a particular programming time, graphs of intervals for said ground stations are used in which each node of a graph is an interval of potential use of equipment on board a satellite and each line is a pair of intervals having portions overlapping in time, and
in said graphs for said ground stations requiring a number L of communication links via different satellites at least equal to two, said communication links are determined by searching for L disjoint node paths.

2. The method claimed in claim 1 wherein, to determine said L disjoint node paths, in said graphs of intervals for said ground stations, the nodes which are necessarily taken by at least one of said L disjoint node paths are identified and are known as L-obligatory nodes.

3. The method claimed in claim 2 wherein, to identify said L-obligatory nodes, for each ground station, after each start and each end of an interval of potential use of equipment of each satellite, the density d for said station, defined as the number of intervals of potential use, is determined and series of densities of the form L+1, L, L+1 are searched for, said L-obligatory nodes being the intervals of potential use that do not terminate or do not commence when said density in said series is the density L.

4. The method claimed in claim 1 wherein, to determine L disjoint node paths for a ground station, L-obligatory handovers, defined as the lines that are necessarily taken by at least one of said disjoint node paths, are identified.

5. The method claimed in claim 4 wherein, to identify said L-obligatory handovers, for each ground station, after each start and each end of an interval of potential use of equipment of each satellite, the density d for said station, defined as the number of intervals of potential use, is determined and series of densities L, L+1, L are searched for in which the variation of density is due to two different intervals, an L-obligatory handover being defined as a handover from the interval that is terminating on passing from the density L+1 to the density L to an interval that is beginning.

6. The method claimed in claim 1 wherein, for each satellite, a graph of intervals is established in which each interval corresponds to a duration of potential use of said satellite by a ground station, the number of antennas of said satellite that are in use at any time is determined, the ground station or stations that cannot be serviced if all the antennas of said satellite are mobilized for other stations are identified, and, in the graph or graphs corresponding to that ground station or those ground stations, said prohibition period is applied to said satellite over the corresponding interval.

7. The method claimed in claim 3 wherein, for each satellite, a graph of intervals is established in which each interval corresponds to a duration of potential use of said satellite by a ground station, the number of antennas of said satellite that are in use at any time is determined, the ground station or stations that cannot be serviced if all the antennas of said satellite are mobilized for other stations are identified, and, in the graph or graphs corresponding to that ground station or those ground stations, said prohibition period is applied to said satellite over the corresponding interval, and wherein, for the ground station or stations in which a prohibition period for the interval of potential use of the corresponding satellite has been reported, the series of densities L+1, L, L+1 are searched for again in order to determine the L-obligatory nodes.

8. The method claimed in claim 5 wherein, for each satellite, a graph of intervals is established in which each interval corresponds to a duration of potential use of said satellite by a ground station, the number of antennas of said satellite that are in use at any time is determined, the ground station or stations that cannot be serviced if all the antennas of said satellite are mobilized for other stations are identified, and, in the graph or graphs corresponding to that ground station or those ground stations, said prohibition period is applied to said satellite over the corresponding interval, and wherein, for the ground station or stations in which a prohibition period for the interval of potential use of the corresponding satellite has been reported, the series of densities L, L+1, L are searched for again in order to determine the L-obligatory handovers.

9. The method claimed in claim 6 wherein the propagation of constraints from the graphs of intervals of satellites to the graphs of intervals of ground stations and vice versa is effected until no situation of saturation is detected any longer, i.e. no satellite having, over a given time interval, visible ground stations that it does not use, but having all its antennas in use.

10. The method claimed in claim 1 wherein, after establishing, during said programming time, communication links subject to interruption and communication links not subject to interruption, a metaheuristic method is used to reduce (or cancel out) the number of links subject to interruption.

11. The method claimed in claim 10 including an intensification step for searching for local optimum solutions and a diversification step and wherein the searches for solutions are conducted over farther away neighborhoods during said diversification step.

12. The method claimed in claim 11 wherein said intensification step searching for local optimum solutions is effected only on links subject to interruption.

13. The method claimed in claim 11 wherein said diversification search is effected on all of the communication links, i.e. those subject and not subject to interruption.

14. A method of planning a set N of requests for services competing for the allocation of M resources with identical characteristics, wherein each service i has to be rendered continuously over a time interval included in a period, said requests for services are divided into groups, each service is rendered by the use of an undifferentiated resource, which resources can render the service i during predefined time intervals known as intervals of potential use, said resources are divided into subsets, a resource is able to render only one service at a time, the requests for services of the same group cannot be rendered by resources belonging to the same subset, the passage from the use of one resource to the next necessitates the simultaneous use of two resources during a minimum duration, a released resource cannot be reused immediately, to determine sequences of resources whose use guarantees at least two continuous services over said period, a graph of intervals is determined for each request for service, each node consists of an interval of potential use of a resource and each line consists of a handover from one resource to another, and, for each request for service, said disjoint node paths are determined in said graph.
